(19) United States
(12) Patent Application Publication
(10) Pub. No.: US 2026/0364862 A1
(43) Pub. Date: Nov. 19, 2026

(54) Molding Preforms with Protective Pockets for Over Molding

(71) Applicant: Jes Tougaard GRAM, George Town (KY)

(72) Inventor: Jes Tougaard GRAM, George Town (KY)

(73) Assignee: Gram Technology, Inc., Scottsdale, AZ (US)

(21) Appl. No.: 19/672,921

(22) Filed: May 11, 2026

Related U.S. Application Data
(60) Provisional application No. 63/808,460, filed on May 19, 2025.

(51) Int. Cl. B29C 45/00; B29C 45/14; B29C 45/77; B29C 45/78; B29K 705/00; B33Y 80/00

(52) U.S. Cl. CPC B29C 45/0046; B29C 45/14065; B29C 45/14819; B29C 45/77; B29C 45/78; B33Y 80/00; B29C 2945/76832; B29C 2945/76929; B29K 2705/00

(57) ABSTRACT

The present invention provides a method of molding preforms with protective pockets/fixtures for inserting of and over molding of 3D printed and/or fragile components.

### FIELD OF INVENTION

The present invention relates to a method of molding preforms with protective pockets/fixtures for inserting of and over molding of 3D printed and/or fragile components including structural improvements of the insert ready components.

### BACKGROUND OF THE INVENTION

Currently when trying to over mold a 3D printed and/or porous and/or fragile product into a plastic part, there are certain challenges that needs to be overcome. This has often to do with the injection pressure needed to fill the mold cavity around the inserted part and/or the high temperature of the molten plastic but also keeping the inserted part in a fixed position when the over molding takes place and sometimes compensating for size and/or volume variation in the insert.

This is specially a challenge when the inserted part variates in size, volume and shape given the variation in the injection molding parameters were shot size, injection pressure and packing parameters must be modified and/or adjusted between molding cycles.

Currently, it is known technology to use low pressure molding to over mold electronic components thereby limiting the scrap percentage compared to high pressure molding due to lack of accuracy of the inserted part were an oversized insert often gets damage by the clamp force pressure and/or the mold cavity having no forgiveness to compensate for the oversize insert and were an undersized insert will create flash and/or loss of control of the inserted part during the molding process.

The challenge of controlling the position of the inserted part in the mold cavity is almost always a problem when over molding an inserted part and when the inserted part varies in size, is a porous and/or fragile insert the problems often becomes critical.

The control of an insert in an over molding process often gives certain design limitations where variation in size of the inserted part as well as porous and/or fragile parts where certain areas can't be exposed to pressure and/or high temperatures of the molten plastic.

Currently there is a push towards consolidating manufacturing steps and having the capability to over mold e.g. plastic, glass, wood, metal parts/structures, assemblies and/or electronics is part of this trend. The challenge is controlling where the plastic flows around the insert given the lack of placement control, consistency in tolerances, compression strength and shutoff capabilities from the molten plastic in a porous and/or fragile part e.g. an electronic component and/or assembly.

3D printing of metal parts/structures is a new and innovative manufacturing technology where any metal theoretically can be used for 3D printing if it is available as a suitable powder that can be used with a 3D printing laser system. E.g. metal powder bed fusion and directed energy deposition, but metal filament extrusion and binder jetting are also viable 3D metal printing solutions.

Binder jetting is an additive manufacturing process in which an industrial printhead selectively deposits a liquid binding agent onto a thin layer of powder particles foundry sand, ceramics, metal or composites to build high-value and one-of-a-kind parts and tooling. Like printing on sheets of paper, the process is repeated layer by layer, using a map from a digital design file, until the object is complete.

Medical implants for knees, hips and other joint and bones replacements are often made from metal and plastic combinations e.g. cobalt-chromium, titanium, peek and polyolefins like polyethylene that are some of the materials FDA approved for implants. Combining/consolidating metal and plastics in implants could give a lot of mechanical, structural, and cost benefits.

Knee replacement, using an artificial joint structure designed to replace an original knee joint. It is usually made of different types of metal and plastic that aim to recreate the same level of mobility as experienced with an undamaged knee.

The makeup of the joint is generally quite straightforward. Metal caps replace both the thigh bone and shin bone, while high-density plastic is used to replace damaged cartilage. Both the tibial component and the femoral component are made of metal. Bone cement is traditionally used to help the implant remain in place.

The most common type of implant features a metal femoral component that rides on a polyethylene plastic spacer attached to the tibial component. The metal components are most made from cobalt-chromium or titanium. Some are coated in zirconium in the event the patient has a pre-existing metal allergy. This combination boasts a long-life span. Whereas advances in technology have reduced the risk, one of the disadvantages of this combination involves the potential for an immune reaction. This is caused by particles wearing away from the plastic spacer.

Of all the available plastic parts involved in total knee replacement, Polyethylene plastic is the most important. While Polyethylene was one of the most common causes of knee revision surgery, technological advances over the past three decades have meant the risks associated with the plastic wearing out have greatly reduced.

The femoral part of knee prostheses is typically made of a cast CoCr Mo-alloy. This can be a problem for sensitive persons that might show allergies against metals such as the highly toxic cobalt, chromium and molybdenum. Tests has showed that cobalt and chromium were deposited in the bone and bone marrow. Therefore, coated femoral components are used for patients with a known metal-sensitivity. These coatings are usually made of titanium nitride or titanium niobium nitride by physical vapor deposition (PVD).

The feasibility to use poly-ether-ether-ketone (PEEK) instead of CoCr Mo for femoral condyles of knee prostheses has been investigated. This replacement would hinder the release of the toxic elements Co, Cr and Mo and this possibly at lower production costs.

PEEK therefore should be considered as an alternative to the CoCr Mo alloy in knee prostheses, especially when used in combination with XLPE liners.

PEEK has been utilized as a biomaterial since the 90s, and since its introduction to the medical community, it has been extremely successful. One of the areas it has gathered the most traction is with spinal fusion procedures as an interbody fusion device. Before PEEK was an alternative for long-term implants titanium was the biomaterial of choice for spinal fusion cages and spacers, but since its introduction, PEEK quickly displaced titanium and is still today the material of choice for the vast majority of spinal fusion cages and spacers.

Before PEEK became the frontline choice for interbody fusion devices, manufacturers relied on titanium to produce the implants. However, PEEK's advantages were too significant to dismiss, and much of the conversation regarding titanium and PEEK has been framed around interbody fusion devices. Even if the debate between PEEK vs. titanium persists, PEEK's future as a valuable biomaterial is certain.

A material's flexural modulus refers to a material's ability to resist bending, so in a way, it describes the material's flexibility. Surgical teams are beginning to realize the value of a flexible biomaterial, especially in orthopedic, trauma fixation and spinal implant applications.

Titanium is a weight-bearing material that trades flexibility for strength. PEEK is much more flexible while still retaining impressive strength. In fact, natural PEEK's modulus is nearly identical to cortical bone's modulus, while titanium is much stiffer than bone.

Flexibility is important because native bone needs the stress of weight to heal properly and retain its vital bone mineral density. Because titanium bears a great deal of weight, it effectively robs native bone of this stimulation. Since PEEK bears weight like bone, it does not cause this issue.

PEEK's ability to bend, or flex, move and bear weight like bone makes it a natural choice for any medical application that includes bone tissue, like trauma fixation and joint replacement. Unsurprisingly, research into PEEK is focused on these applications.

The current invention enables a unique combination of injection molding and 3D printing where e.g. the benefits of a 3D printed titanium part can be combined with the benefits of PEEK by molding them together according to the invention.

Here an extra process of machining the 3D printed part after printing to remove unwanted fixture or areas of the 3D printed part e.g. enabling tighter measurements and cleaner/better surfaces could be part of the manufacturing process.

Custom-made knee implants put the patient at the center of implant design and combining advanced 3D imaging technology with the latest manufacturing technologies it is possible to manufacture individual implants based on each patient's unique size and shape, but both cost and time to manufacture limits the implementation of the personalized implant opportunity.

3D Imaging in healthcare is a collection of techniques and tools used to post-process medical scan data. Unlike 2D imaging, which offers flat, linear views limited to length and width, 3D imaging adds depth, providing a comprehensive representation in three dimensions: length, width, and height (x, y, z coordinates).

This depth enables detailed anatomical visualizations of the human body, using technologies such as CT, MRI, and Ultrasound. While 2D methods like X-rays and standard ultrasounds are effective for general imaging, they lack the capability to offer the thorough perspective that 3D imaging provides. 3D imaging has revolutionized medical diagnosis and treatment, giving healthcare professionals deeper insights into complex health conditions and the ability to make personalized joint replacement parts based on individual patients' actual joint autonomy.

Lost core technology is an insert molding technology where a low temperature or dissolvable material core molded and then inserted into a mold cavity, followed by introducing plastic material into cavity and around the inserted core, whereafter ejection from the mold the ejected molded part will have the lost core material melted and/or dissolved away leaving a finished molded part.

Using other 3D printing methods and materials for mold parts can open new possibilities where e.g. using bottom-projection 3D printers that employ solidifying radiation to solidify a reactive liquid that is housed in a liquid container could provide additionally personalized manufactured core and/or cavity mold parts used only for a single or a few moldings.

U.S. Pat. No. 11,969,918 describes an invention that relates to sacrificial additively manufactured molds consisting of a dissolvable material for use in thermoplastic injection molding processes at plastic melt temperatures in the range of 70-450 degrees C and injection pressures in the range of 0.2-400 MPa. The invention also relates to a method of producing a molded article using said sacrificial additively manufactured molds.

This 3D printing technology could also be used to make sacrificial core and/or cavity parts consisting of dissolvable material in full or in part that may be used/inserted in the thermoplastic injection molding processes according to the invention at plastic melt temperatures in the range of 70-450 degrees C and injection pressures in the range of 0.2-400 MPa.

A sacrificial core and/or cavity insert is a single-use mold part that is sacrificed after the molded article is released from the mold, for example by use of mechanical means, high temperature, such as pyrolysis or by chemical and/or fluid means, such as dissolving.

By the term “sacrificial mold part” is meant a mold part insert consisting of a dissolvable material in full and/or in part that surrounds and/or encloses the introduced molten resin/plastic in full and/or in part where also uncured material e.g. silicone could be used in full and/or in part where a curing process is part of the manufacturing process.

The 3D printed mold parts can be capable of sustaining plastic melt temperatures in the range of 70-450 degrees C and capable withstanding injection pressures suitable for use in thermoplastic injection molding processes and/or e.g. LIM silicone molding/curing. During the molding process, the mold cavity including at least one 3D printed mold part is filled by introducing the plastic and/or silicone into at least one cavity of the mold.

3D printing using additive manufacturing by means of photopolymerization or similar means, where the resin formulation may include a curing agent. The type of curing agent depends on the resin in the formulation and the preferred method for curing.

The resin can be radiation curable, also known as energy curable, and in such cases the resin is cured by applying for example ultraviolet light or electron beam radiation to the resin formulation. Curing silicone using this method could also be an option according to the invention where reusable insert and/or flexible inserts with high heat tolerance where needed.

The over molding challenges of porous and/or fragile components e.g. electronics and/or batteries are currently attempted resolved by low pressure molding having limited choice in material selections. The control and flexibility in materials and manufacturing methods in the over molding process is what the current invention aim to solve.

Therefore, the production yield according to the invention can be improved by using e.g. the P&G iMFLUX technology U.S. Pat. No. 9,643,351 that controls the material injection into the mold real-time in closed-loop feedback that maintains low constant pressure and also compensate for material viscosity and shot weight variations real-time enabling a more uniform manufacturing process with less flash and short shots in the over molding process resulting in less scrap.

It is apparent now that numerous methods and systems are developed in the prior art that are adequate for various purposes. Furthermore, even though these inventions may be suitable for the specific purposes to which they address, accordingly, they would not be suitable for the purposes of the present invention as heretofore described. Thus, a method solving challenges in over molding metal, porous and/or fragile parts/structures and/or electronics will be in great demand.

### SUMMARY OF THE INVENTION

The present invention discloses method of molding preforms with protective pockets/fixtures for inserting of and over molding of 3D printed and/or fragile components as well as composition/configuration and design of such inserts\components improving the over molding process.

This can be done by e.g. over molding a preform introduced or molded into a cavity of a mold having at least one insert introduced into said protective pockets/fixtures in an apparatus capable of introducing at least one portion of molten plastic into the mold, wherein the apparatus includes the ability of controlling the plastic temperature and pressure introduced in a cavity.

The plastic type, temperature and pressure will then determine how the molten plastic will embed itself around the inserted part and decide the adhesion level of the assembled part. The apparatus could have multi shot capabilities for different volumes or materials or even curing silicone in the combined process in addition to both chemical and/or mechanical bonding options.

Other objectives and aspects of the invention will become apparent from the following detailed description, taken in conjunction with the accompanying drawings, which illustrate, by way for example, the features in accordance with embodiments of the invention.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

Although, the invention is described above in terms of various exemplary embodiments and implementations, it should be understood that the various features, aspects, and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments.

The presence of broadening words and phrases such as “one or more,” “at least,” “but not limited to” or other like phrases in some instances shall not be read to mean that the narrower case is intended or required in instances where such broadening phrases may be absent.

### DETAILED DESCRIPTION OF THE INVENTION

The present specification is directed towards multiple embodiments. The following disclosure is provided in order to enable a person having ordinary skill in the art to practice the invention. Language used in this specification should not be interpreted as a general disavowal of any one specific embodiment or used to limit the claims beyond the meaning of the terms used therein.

The general principles defined herein may be applied to other embodiments and applications without departing from the spirit and scope of the invention. Also, the terminology and phraseology used is for the purpose of describing exemplary embodiments and should not be considered limiting.

Thus, the present invention is to be accorded the widest scope encompassing numerous alternatives, modifications and equivalents consistent with the principles and features disclosed. For purpose of clarity, details relating to technical material that is known in the technical fields related to the invention have not been described in detail so as not to unnecessarily obscure the present invention.

The method according to the invention could have the following steps; Molding and/or introducing a preform having at least one protective pocket/area having and/or receiving at least one 3D printed and/or fragile components in a cavity of the mold; Confirming position of the preform and insert in a cavity; Closing the mold and introducing molten plastic into the cavity; Controlling the plastic pressure and temperature that is applied in the mold and cavities, wherein the pressure level of the molten plastic and temperature level of the molten plastic will decide the adhesion level and/or mechanical bonding between preform and the plastic; Opening the mold and removing the new combined preform, insert and over molded part from the cavity; Collecting the combined part and if including a sacrificial core and/or cavity placing it a melting and/or a dissolving fluid.

The present invention also enables personalized injection molded implants by combining advanced 3D imaging technology with ability of 3D printing sacrificial core and/or cavity parts consisting of dissolvable material in full or in part that may be used/inserted in the thermoplastic injection molding processes according to the invention.

The present invention discloses a method of molding preforms with protective pockets/fixtures for inserting individual 3D printed sacrificial core and/or cavity parts made using 3D imaging technology to make it e.g. a personalized joint part matching the individual in question and having a matching part dimension matching the protective pockets/fixtures while the personalized part is determined by the 3D imaging technology data.

Using the matching part dimension matching the protective pockets/fixtures to secure a continues production of personalized 3D printed sacrificial core and/or cavity parts having the iMFLUX technology compensating for variation in shot size to the various personalized inserts.

Thereby making it possible to manufacture individual implants based on each patient's unique size and shape at a reasonably cost and time enabling implementation of the personalized implant opportunity for a larger audience.

The present invention also enables inserts where the combined preform and over molded plastic enclose at least one 3D printed metal insert having more than one density/3D print resolution areas e.g. containing solid and a porous surfaces/area in the same insert where a different percentage, weight or volume of each part of solid or porous density determines the insert according to the invention.

The present invention also enables insert where the combined preform and over molded plastic enclose at least one post machined 3D printed metal core and/or cavity part in full or in part. This can be done by 3D printing a metal core and/or cavity part and then machining it into the correct tolerances and/or surfaces.

3D printing protective layers on top of electronics parts and/or assemblies as well as closing/attaching other 3D printed parts and/or fragile components into and/or onto pre-molded parts.

The present invention also enables inserts where the protected pocket/fixture of the preform in addition to the insert is supplied with at least one extra pre-molded protected pocket/fixture e.g. a lid/cap preform to protect the insert against heat and pressure from the following introduced plastic material.

A sacrificial additively manufactured mold part may be manufactured by selectively curing a liquid resin formulation. The resin formulation preferable would be a dissolvable resin formulation that after 3D printing the mold part and inserting it into a cavity of the mold whereafter a desired material introduced into the mold cavity to create a molded object. The molded object is then ejected/removed with and/or without the 3D printed mold part that then can react with water or another solvent whereby the 3D printed mold part is dissolved to release the molded object.

The method in accordance with the invention could use 3D printing sacrificial core and/or cavity parts consisting of dissolvable material in full or in part that may be used/inserted in the thermoplastic injection molding processes according to the invention using biodegradable materials alone and/or in combination with other materials with bonding capabilities or lack of same e.g. for stents and other implants that can release from the protective pockets/fixtures after molding because the materials don't chemical bond.

In the description and claims of the application, each of the words “units” represents the dimension in any units such as centimeters, meters, inches, foots, millimeters, micrometer, percentages and the like and forms thereof, are not necessarily limited to members in a list with which the words may be associated.

In the description and claims of the application, each of the words “comprise”, “include”, “have”, “contain”, and forms thereof, are not necessarily limited to members in a list with which the words may be associated.

Thus, they are intended to be equivalent in meaning and be open-ended in that an item or items following any one of these words is not meant to be an exhaustive listing of such item or items or meant to be limited to only the listed item or items. It should be noted herein that any feature or component described in association with a specific embodiment may be used and implemented with any other embodiment unless clearly indicated otherwise.

Regarding applicability of 35 U.S.C. § 112, ¶16, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items from the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible.

For example, substitutions, additions, or modifications may be made to the elements illustrated in the drawings, and the methods described herein may be modified by substituting, reordering, or adding stages to the disclosed methods.

Accordingly, the following detailed description does not limit the disclosure. Instead, the proper scope of the disclosure is defined by the appended claims. The present invention contains headers. It should be understood that these headers are used as references and are not to be construed as limiting upon the subjected matter disclosed under the header.

This specification includes references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

The presence of broadening words and phrases such as “one or more,” “at least,” “but not limited to” or other like phrases in some instances shall not be read to mean that the narrower case is intended or required in instances where such broadening phrases may be absent.

It must also be noted that as used herein and in the appended claims, the singular forms “a,” “an,” and “the” include plural references unless the context dictates otherwise. Although any systems and methods similar or equivalent to those described herein can be used in the practice or testing of embodiments of the present disclosure, the preferred, systems and methods are now described.

### BRIEF DESCRIPTION OF DRAWINGS

FIG. 1 illustrates a test coupon/first shot with a protective pocket ready for the insert to be secured in position during an over molding in accordance with the present invention.

FIG. 2 illustrates an insert ready for insertion into the protective pocket of the first molding in accordance with the present invention.

FIG. 3 illustrates an 3D printed insert having a high resolution that can be machined for insert size precision and/or shutoff area and plastic encapsulation having an exposed low-resolution/porous area for accommodating bone growth, the insert ready for insertion into the protective pocket of the first molding in accordance with the present invention.

FIG. 4 illustrates insert placed in the protective pocket of the preform using the method in accordance with the present invention.

FIG. 5 illustrates a finished over molded part with the insert placed in the protective pocket of the preform using the method in accordance with the present invention.

FIG. 6 illustrates a side view of a finished over molded insert placed in the protective pocket of the preform using the method in accordance with the present invention.

FIG. 7 illustrates a side view of a finished over molded sacrificial insert placed in the protective pocket of the preform using the method in accordance with the present invention.

FIG. 8 illustrates a side view of a finished over molded part after the sacrificial insert had been dissolved/removed from its position in the protective pocket of the over molded preform using the method in accordance with the present invention.

The accompanying drawings illustrate various embodiments of systems, methods, and embodiments of various other aspects of the disclosure. Any person with ordinary skills in the art will appreciate that the illustrated element boundaries (e.g. boxes, groups of boxes, or other shapes) in the figures represent one example of the boundaries.

It may be that in some examples one element may be designed as multiple elements or that multiple elements may be designed as one element. In some examples, an element shown as an internal component of one element may be implemented as an external component in another and vice versa. Furthermore, elements may not be drawn to scale. Non-limiting and non-exhaustive descriptions are described with reference to the following drawings.

The components in the figures are not necessarily to scale, emphasis instead being placed upon illustrating principles. Furthermore, the drawings may contain text or captions that may explain certain embodiments of the present invention. This text is included for illustrative, non-limiting, explanatory purposes of certain embodiments detailed in the present invention. In the drawings:

Embodiments of the invention are described with reference to the following figures. The same numbers are used throughout the figures to reference like features and components. The features depicted in the figures are not necessarily shown to scale. Certain features of the embodiments may be shown exaggerated in scale or in somewhat schematic form, and some details of elements may not be shown in the interest of clarity and conciseness.

### DESCRIPTION OF DRAWINGS

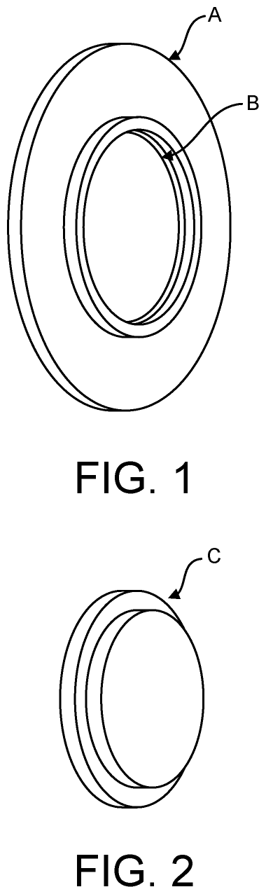

FIG. 1 illustrates a test coupon/first shot (A) with a protective pocket (B) ready for the insert to be secured in position during an over molding in accordance with the present invention.

FIG. 2 illustrates an insert (C) ready for insertion into the protective pocket of the first molding in accordance with the present invention.

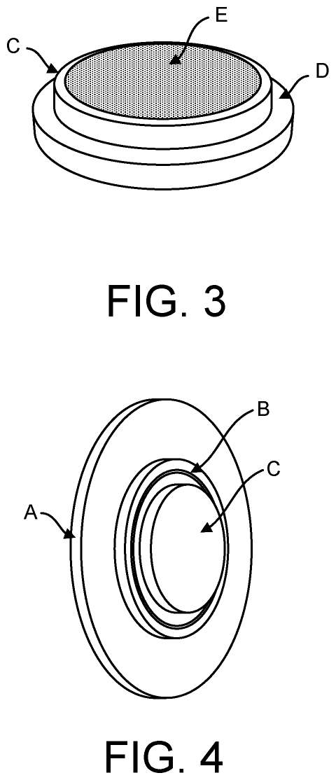

FIG. 3 illustrates an 3D printed insert (C) having a high-resolution outer surface (D) that can be machined for insert size precision and/or shutoff area and plastic encapsulation and having an exposed low-resolution/porous area (E) for accommodating e.g. bone growth, the insert ready for insertion into the protective pocket of the first molding in accordance with the present invention.

FIG. 4 illustrates insert (C) placed in the protective pocket (B) of the preform (A) using the method in accordance with the present invention.

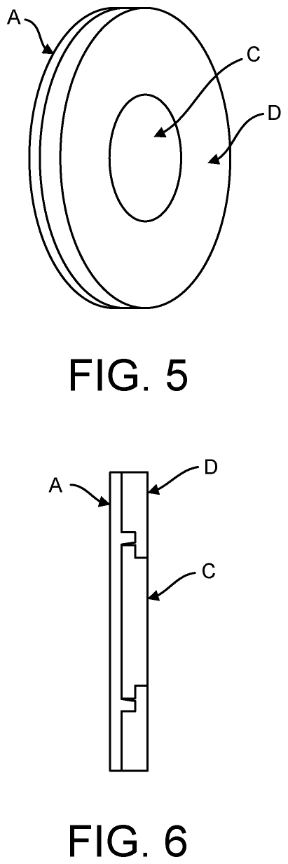

FIG. 5 illustrates a finished over molded part (D) with the insert (C) placed in the protective pocket of the preform (A) using the method in accordance with the present invention.

FIG. 6 illustrates a side view of a finished part (D) over molded preform (A) with the insert (C) placed in the protective pocket of the preform using the method in accordance with the present invention.

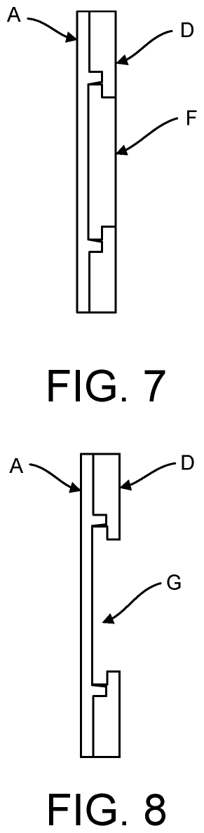

FIG. 7 illustrates a side view of a finished part (D) over molded sacrificial insert (F) placed in the protective pocket of the preform (A) using the method in accordance with the present invention.

FIG. 8 illustrates a side view of a finished part (D) over molded part after the sacrificial insert had been dissolved/removed (G) from its position in the protective pocket of the over molded preform (A) using the method in accordance with the present invention.

While illustrative implementations of the application have been described in detail herein, it is to be understood that the inventive concepts may be otherwise variously embodied and employed, and that the appended claims are intended to be construed to include such variations, except as limited by the prior art.

Reference throughout this specification to “one implementation” or “an implementation” means that a particular feature, structure, or characteristic described in connection with the implementation is included in at least one implementation of the present invention. Thus, the appearances of the phrases “in one implementation” or “in some implementations” in various places throughout this specification are not necessarily all referring to the same implementation. Furthermore, the particular features, structures, or characteristics may be combined in any suitable manner in one or more implementations.

Systems and methods describing the present invention have been described. It will be understood that the descriptions of some embodiments of the present invention do not limit the various alternative, modified, and equivalent embodiments which may be include within the spirit and scope of the present invention as defined by the appended claims. Furthermore, in the detailed description above, numerous specific details are set forth to provide an understanding of various embodiments of the present invention. However, some embodiments of the present invention may be practiced without these specific details. In other instances, well known methods, procedures, and components have not been described in detail so as not to unnecessarily obscure aspects of the present embodiments.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. A method of manufacturing an overmolded assembly comprising: having a molded preform that defines a protective pocket in a cavity of an injection mold; positioning a component in the protective pocket such that the protective pocket locates the component relative to the preform; closing the injection mold; introducing a molten polymer into the cavity around at least a portion of the preform and at least a portion of the component while controlling a pressure of the molten polymer; solidifying the molten polymer to form an overmolded polymer portion joined to the preform, with the component retained in the protective pocket; opening the injection mold; and removing from the cavity the overmolded assembly comprising the preform, the component, and the overmolded polymer portion, wherein the previously molded preform remains incorporated in the overmolded assembly.

21. The method of claim 20, wherein introducing the molten polymer comprises using closed-loop feedback to regulate the pressure of the molten polymer in real time and to compensate for a change in material viscosity or shot weight.

22. The method of claim 20, wherein the component comprises a three-dimensionally printed component that is at least partially enclosed by the preform and the overmolded polymer portion.

23. The method of claim 22, wherein the three-dimensionally printed component comprises metal.

24. The method of claim 23, wherein the three-dimensionally printed component includes a relatively dense region and a porous region within the same metal component.

25. The method of claim 23, further comprising machining at least one surface of the three-dimensionally printed metal component before positioning the component in the protective pocket.

26. The method of claim 20, wherein the component comprises a sacrificial component comprising a dissolvable material, and further comprising dissolving at least a portion of the sacrificial component after forming the overmolded assembly.

27. The method of claim 26, wherein the sacrificial component is three-dimensionally printed and is contacted by the overmolded polymer portion during introduction of the molten polymer.

28. The method of claim 20, further comprising positioning a separately formed protective cap over at least part of the component after positioning the component in the protective pocket and before introducing the molten polymer.

29. The method of claim 20, wherein first and second different three-dimensionally printed metal components are positioned in respective protective pockets of the preform and are at least partially enclosed by the overmolded polymer portion.

30. The method of claim 22, wherein at least a portion of a geometry of the three-dimensionally printed component is generated from scan data representing a body part.

31. The method of claim 20, wherein the component includes both a three-dimensionally printed metal portion and a sacrificial portion comprising a dissolvable material.

32. The method of claim 26, wherein the sacrificial component is formed from a material that does not chemically bond to the preform or the overmolded polymer portion, thereby permitting separation of the sacrificial component from the protective pocket after molding.

33. The method of claim 30, wherein the three-dimensionally printed component is a patient-specific joint component having an interface portion of a predetermined dimension corresponding to the protective pocket and a patient-specific remainder determined from the scan data.

34. The method of claim 33, further comprising successively manufacturing a plurality of patient-specific components having respective patient-specific geometries and interface portions having the predetermined dimension, while using closed-loop pressure control to compensate for shot-weight variation among the patient-specific components.

35. The method of claim 26, wherein the sacrificial component defines identifying indicia that remain visible on the overmolded assembly after the sacrificial component is dissolved.

36. The method of claim 20, wherein the protective pocket includes at least one deformable rib that contacts the component and deforms to accommodate a dimensional variation of the component while retaining the component in the protective pocket.

37. The method of claim 26, wherein the preform, the overmolded polymer portion, and the sacrificial component are removed together from the injection mold before the sacrificial component is dissolved.

38. The method of claim 20, wherein an uncured curable material is introduced into the protective pocket and subsequently cured as part of forming the overmolded assembly.

39. A method of manufacturing an implant component, the method comprising: additively manufacturing a metal insert having a first region with a first density and a porous second region with a second density lower than the first density; positioning the first region of the metal insert in a protective pocket of a previously molded preform while leaving at least a portion of the porous second region outside the protective pocket; introducing a molten polymer around at least a portion of the preform and the first region of the metal insert; solidifying the molten polymer to join the metal insert to the preform while leaving at least a portion of the porous second region exposed; and removing from a mold an assembly comprising the preform, the metal insert, and the solidified polymer.
